(19) United States
(12) Patent Application Publication
(10) Pub. No.: US 2025/0342266 A1
(43) Pub. Date: Nov. 6, 2025

(54) DATA POSTURE ANALYSIS USING A DISTINCT SCANNER ENVIRONMENT

(71) Applicant: Proofpoint, Inc., Sunnyvale, CA (US)

(72) Inventors: Yang ZHANG, Fremont, CA (US); Ajay Agrawal, Bangalore (IN); Ravishankar Ganesh ITHAL, Los Altos, CA (US)

(73) Assignee: Proofpoint, Inc., Sunnyvale, CA (US)

(21) Appl. No.: 19/197,826

(22) Filed: May 2, 2025

(30) Foreign Application Priority Data
May 2, 2024 (IN) 202411034821

(51) Int. Cl. G06F 21/62

(52) U.S. Cl. CPC G06F 21/6218

(57) ABSTRACT

The technology disclosed relates to systems and methods for analyzing data posture in a computing environment. In one example, a computer-implemented method includes identifying one or more computing services in a target computing environment to scan for data posture analysis, obtaining an access permission corresponding to the one or more computing services in the target computing environment, and deploying, to a scanner cloud environment that is distinct from the target computing environment, a scanner in accordance with a scanner definition and based on the access permission corresponding to the one or more computing services. The method includes obtaining a scanner result from the scanner deployed to the scanner cloud environment. The scanner result represents a scan of storage resources in the one or more computing services in the target computing environment using the access permission. The method further includes generating a data posture analysis result based on the scanner result.

### CROSS-REFERENCE TO RELATED APPLICATION

The present application claims the benefit of Indian Application No. 202411034821, filed May 2, 2024, the contents of which is hereby incorporated by reference in its entirety.

### FIELD OF THE TECHNOLOGY DISCLOSED

The technology disclosed generally relates to data posture analysis on computing environments, such as cloud environments, that provide user access to storage resources for data storage. More specifically, but not by limitation, the present disclosure relates to improved systems and methods of cloud security posture management (CSPM), cloud infrastructure entitlement management (CIEM), cloud-native application protection platform (CNAPP), cloud-native configuration management database (CMDB), and/or data security posture management (DSPM).

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

There are many types of computing environments that provide data storage resources for organizations or other end users. Cloud computing, for example, provides on-demand availability of computer resources, such as data storage and compute resources, often without direct active management by users. Thus, a cloud environment can provide computation, software, data access, and storage services that do not require end-user knowledge of the physical location or configuration of the system that delivers the services. In various examples, remote servers can deliver the services over a wide area network, such as the Internet, using appropriate protocols, and those services can be accessed through a web browser or any other computing component.

Cloud storage services provide on-demand network access to a shared pool of configurable resources. These resources can include networks, servers, storage, applications, services, etc. The end-users of such cloud services often include organizations that have a need to store sensitive and/or confidential data, such as personal information, financial information, and medical information in cloud storage. Such information can be accessed by any of a number of users through permissions and access control data assigned or otherwise defined through administrator accounts.

The discussion above is merely provided for general background information and is not intended to be used as an aid in determining the scope of the claimed subject matter.

### SUMMARY

The technology disclosed herein generally relates to data posture analysis on computing environments, such as cloud environments and/or on-premise environments, that provide user access to storage resources for data storage. In one example, a computer-implemented method includes identifying one or more computing services in a target computing environment to scan for data posture analysis, obtaining an access permission corresponding to the one or more computing services in the target computing environment, and deploying, to a scanner cloud environment that is distinct from the target computing environment, a scanner in accordance with a scanner definition and based on the access permission corresponding to the one or more computing services. The method includes obtaining a scanner result from the scanner deployed to the scanner cloud environment. The scanner result represents a scan of storage resources in the one or more computing services in the target computing environment using the access permission. The method further includes generating a data posture analysis result based on the scanner result.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a block diagram illustrating one example of a cloud architecture.

FIG. 2 is a block diagram illustrating one example of a cloud service.

FIG. 3 is a block diagram illustrating one example of a cloud data posture analysis system.

FIG. 4 is a block diagram illustrating one example of a data scanner.

FIG. 5 is a flow diagram illustrating one example of analyzing data posture in a computing environment.

FIG. 6 is a flow diagram illustrating one example of identifying computing services.

FIG. 7 one example of a user interface display to onboard computing services to be scanned.

FIG. 8 illustrates one example of a user interface display.

FIG. 9 illustrates one example of a user interface display.

FIG. 10 illustrates one example of a user interface display.

FIG. 11 is a flow diagram illustrating execution of scanner instances to scan data stores in target cloud services, in one example.

FIG. 12 is a simplified block diagram of one example of a client device.

FIG. 13 shows an example computer system.

### DETAILED DESCRIPTION

The following discussion is presented to enable any person skilled in the art to make and use the technology disclosed, and is provided in the context of particular applications and their requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein.

As noted above, computing environments, such as cloud environments and/or on-premise environments, are used by organizations or other end-users to store a wide variety of different types of information in many contexts and for many uses. This data can often include sensitive and/or confidential information, and can be the target for malicious activity such as acts of fraud, privacy breaches, data theft, etc. These risks can arise from individuals that are both inside the organization as well as outside the organization.

With the growing need to detect and prevent policy violations of sensitive and/or private information, data security has become increasingly crucial. To take proactive measures to safeguard sensitive and/or private information, these computing environments often include security infrastructure to enforce access control, data loss prevention, or other processes to secure data from potential vulnerabilities, such as unauthorized access or breaches.

One approach performs data posture analysis on the data stores using one or more scanners. Data posture analysis refers to processes that evaluate the security and/or compliance status of data within a computing environment, for example by examining one or more of access controls, data sensitivity, potential vulnerabilities, or the like. Data posture analysis can involve a scanner, such as a computer program running on a physical machine and/or virtual machine, deployed to access and scan the data stores and detect sensitive and/or private data, or other target data of interest, assess risk exposure, and generate insights to enhance data protection and prevent unauthorized access or breaches.

As an example, scanners are used to scan on-premise data stores and/or data stores in a cloud environment, such as in an organization's cloud accounts, data warehouses, and/or software as a service (SaaS) applications. In one example deployment model, to scan an on-premise data store the user brings up a virtual machine in the on-premise environment so the scanner is physically or logically close to the data store being scanned. The scanner runs in a local virtual machine in the same network as the data store. In this case, the user manually brings up the virtual machine, deploys the scanner code, and manages the lifecycle of the virtual machine, which is not only inconvenient, but also error prone. Further, the approach is typically not scalable. For instance, considering a data store with a large volume of data, a single scanner may take a very long time to finish a scan. Further, in some cloud-based data warehouses or SaaS applications that don't adequately support deployment of computing resources in the data environment, it may be impossible to deploy a scanner. Data in such environments may remain unscanned, thus contributing to security vulnerability risk.

The present system is directed to a data posture analysis system that leverages computing resources, such as cloud computing resources, to deploy scanners to scan various target computing environments, which can include cloud computing environments and/or on-premise computing environments. The posture analysis system performs cross service data store scanning as the scanners are deployed in a distinct scanner environment that is separate from the target environment in which the data store(s) to be scanned reside. In this way, the scanners can be deployed in cloud or other computing services, separate from the services that include the storage resources being scanned, allowing for cross service data store scanning of a number of data store services in parallel. Further, resources in the cloud environment, such as server-less computing resources and/or virtual machines, can be used to deploy containerized scanners that are dynamically scalable based on the number of cloud resources to be scanned. As used herein, a target environment refers to an environment, such as a target cloud environment and/or target on-premise environment, having the services to be scanned. Further, a scanner environment refers to an environment, such as a scanner cloud environment and/or scanner on-premise environment, in which the scanners are deployed to scan the target environment. In some described examples, the management of the scanning resources in the scanner environment does not require manual management by an end user. Instead, for example, the scanning resources in the scanner environment can be automatically managed through the cloud provider and/or workflows.

For sake of illustration, but not by limitation, advantages of examples described herein include increased scanner capability as the use of a cloud environment facilitates the ability to scan data warehouses and SaaS applications, which is not possible in some traditional deployment models. Further, the approach allows for scalability on demand and improvements in flexibility and management from the perspective of the organizations as end users can select which cloud environments will be used as the scanner environment and what types of resources (e.g., serverless resources, virtual machines) will be used to deploy the scanners based on preference, availability, and/or functionality.

Through the scanner results, the present approach can discover sensitive data among storage resources and discover access patterns to the sensitive data. The results can be used to identify security vulnerabilities to understand data security posture, detect and remedy the security vulnerabilities and prevent future breaches of sensitive data, for example.

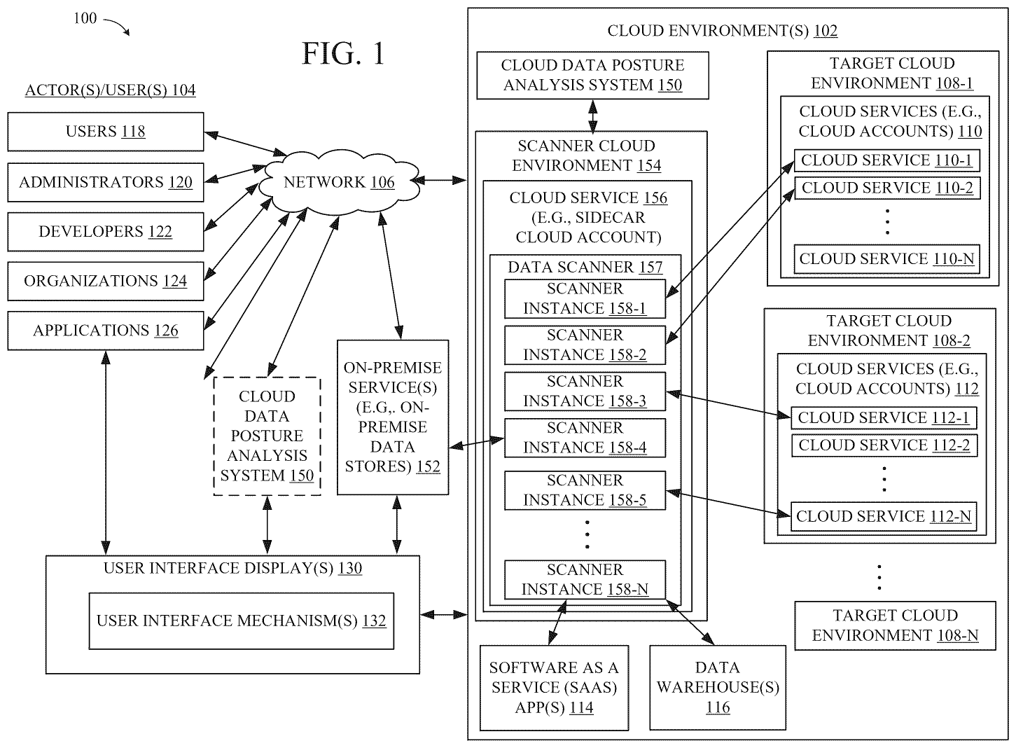

FIG. 1 is a block diagram illustrating one example of a cloud architecture 100 in which one or more cloud environments 102 have resources provided by cloud services, such in cloud accounts, that are accessed by one or more actors 104 through a network 106, such as the Internet or other wide area network.

Cloud services include the resources and functionalities provided by a cloud platform, such as virtual machines, storage, databases, and various software tools. A cloud account may be viewed as an access mechanism for cloud services offered by a cloud provider. Therefore, the cloud services can be accessed and utilized through a cloud account, which serves as a mechanism for authentication and authorization to interact with the cloud provider's infrastructure and services. A cloud account can provide a gateway or entry point to the cloud environment where the cloud services reside.

Within this context, at least some examples described herein may use the terms cloud account and cloud service interchangeably. In this way, the term cloud account can refer to an object in cloud architecture 100 that represents a connection to a cloud service provider (or multiple cloud service providers) by using a particular set of credentials. The term cloud account can also refer to one or more cloud services, e.g., to which a user identity is associated in a cloud computing platform.

For sake of illustration, but not by limitation, a user identity is granted authorized access to the platform's resources. For example, a user identity can include a username and password or other authentication credentials, stored securely by the cloud provider. The particular form of the credentials can differ depending on the type of cloud service provider. A cloud account enables users to provision, manage, and utilize computing resources, such as virtual machines, storage, databases, and applications, hosted on the cloud provider's infrastructure via internet-based interfaces or APIs. Access permissions and privileges associated with a cloud account are managed by the cloud provider's identity and access management (IAM) system, allowing administrators to control resource usage, security configurations, and collaboration among users within an organization. Accordingly, a cloud account enables users to deploy and manage various computing resources without needing to invest in physical hardware or maintain on-premises infrastructure. A cloud account also allows for scalability, as users can easily increase or decrease resources based on needs, and provides flexibility in terms of accessing and managing data and applications.

As illustrated in FIG. 1, cloud environment(s) 102 include one or more target cloud environments 108-1, 108-2, and 108-N(collectively referred to as target cloud environments 108). Each target cloud environment 108 includes one or more cloud services, which can include, for example, data stores within storage resources, that are to be targeted for scanning. For instance, target cloud environment 108-1 includes cloud services 110-1, 110-2, and 110-N(collectively referred to as cloud services 110) and target cloud environment 108-2 includes cloud services 112-1, 112-2, 112-N(collectively referred to as cloud services 110). Further, target cloud environment 108-N can also include one or more cloud services (not illustrated in FIG. 1).

Cloud services 110 and/or 112 can include cloud storage services such as, but not limited to, AWS, GCP, Microsoft Azure, to name a few. Further, cloud services 110 and/or 112 can include the same type of cloud service, or can be different types of cloud services, and can be accessed by any of a number of different actors 104. In this way, cloud environment(s) 102 can be a multi-cloud.

Additionally, other cloud services within cloud environment 102 can include, but are not limited to, software as a service (SaaS) application(s) 114 and data warehouses 116. An example data warehouse 116 includes a specialized database designed for storing and analyzing structured, historical data from various sources, and can be optimized for analytical queries, reporting, and organizational intelligence purposes.

As illustrated in FIG. 1, actors 104 include users 118, administrators 120, developers 122, organizations 124, and/or applications 126. Of course, other actors can access cloud environment 102 as well.

Users 118, administrators 120, developers 122, or other actors can interact with cloud environment 102 through user interface displays 130 having user interface mechanisms 132. For example, a user can interact with user interface displays 130 provided on a user device (such as a mobile device, a laptop computer, a desktop computer, etc.) either directly or over network 106. Cloud environment 102 can include other items as well.

Architecture 100 includes a cloud data posture analysis system 150 configured to access computing services, such as cloud services 110 and/or 112, in target cloud environments 108 and/or on-premise services 152 in target on-premise environments. On-premise computing includes deployment and management of computing resources, such as servers, storage, network equipment, and software applications within the physical premises of an organization. This approach typically involves the ownership, operation, and maintenance of hardware and software infrastructure by the organization itself, as opposed to utilizing cloud-based services provided by third-party vendors.

In some examples, an organization has multiple cloud accounts across multiple target cloud environments 108, and these multiple cloud accounts form a multi-cloud utilizing different cloud providers. Alternatively, or in addition, the organization can also have one or more on-premise services with on-premise data stores storing data of the organization. Cloud data posture analysis system 150 is configured to identify one or more target environments to be scanned and to deploy a scanner into a scanner environment, such as a scanner cloud environment 154.

As noted above, the scanner environment includes one or more computing services, such as a cloud service 156, in which scanners are deployed to scan the one or more target environments. The one or more computing services in the scanner environment are separate and distinct services from the services to be scanned in the target environment(s).

In the context of deploying scanners for data posture analysis, separate and distinct refer to the deployment of scanning resources in a scanner environment that is independent from the target environment(s) where the data resides. The scanner environment is independent from the target environment(s) in that there is operational autonomy of services in the scanner environment from services in the target environment(s). For instance, deployment of scanners in the scanner environment does not require the changing of code or functionality of the services in the target environment.

The separation of the scanner environment from the target environment can reduce the likelihood that the scanning operations interfere with the normal functioning of the target environment, thereby encouraging performance and stability in the target environment.

By utilizing a distinct environment, the scanners can operate with their own set of permissions and configurations, which are different from and isolated from those of the target environment. In one example, the scanners operate on a different set of machines (physical and/or virtual) than the services in the target environment. This approach enhances security by minimizing the risk of unauthorized access to the target environment's resources during the scanning process. Additionally, the distinct environment allows for greater flexibility and scalability, as the scanning resources can be dynamically adjusted without impacting the target environment's infrastructure or operations.

Further, the scanners deployed in the separate scanner environment can operate to scan data stores in a plurality of different target environments in parallel. For instance, a first scanner in the scanner environment can scan an on-premise data store, while a second scanner in the scanner environment scans a first data store provided by a first cloud provider, a third scanner in the scanner environment scans a second data store provided by a second cloud provider, and a fourth scanner in the scanner environment scans an SaaS application.

In one example, cloud service 156 comprises a sidecar cloud account, which refers to a secondary or auxiliary account that is associated, to some extent, with the cloud accounts being scanned in target cloud environments 108. A sidecar account can have distinct permissions, access controls, or configurations compared to the target cloud accounts, and can be deployed in distributed systems, containerized environments, or cloud platforms to facilitate separation of duties, resource isolation, or to meet specific operational requirements.

A containerized scanner refers to a scanning application that is packaged within a container, utilizing containerization technology to ensure consistent and efficient deployment across various computing environments. Containerization encapsulates the scanner along with the scanner's dependencies, libraries, and configuration files, creating a lightweight, portable unit that can be executed reliably on any platform supporting container technology, such as Docker or Kubernetes. This approach allows the scanner to be deployed rapidly and scaled dynamically, leveraging cloud resources like serverless computing or virtual machines. Containerized scanners offer advantages in terms of resource efficiency, isolation, and ease of management, enabling organizations to perform data posture analysis across diverse environments with little, if any, need for manual configuration or management of underlying infrastructure.

In one particular example, a sidecar account includes a separate container that runs alongside an application container in a Kubernetes pod. For instance, a sidecar can include a container that runs alongside an application container unit in an elastic container service (ECS) task. The organization can include one or more primary cloud accounts dedicated to production workloads and a secondary cloud account designated as a sidecar account that operates the scanner in a manner that allows scanning of all of the primary cloud accounts in parallel while reducing processing load on the primary environments. The sidecar account can also isolate resources or applications with different security requirements which can enhance security within the scanning tasks.

In the context of the example of FIG. 1, system 150 deploys data scanner 157 into cloud service 156, such as a sidecar cloud account. Data scanner 157 is dynamically scalable to include a number of scanner instances 158-1, 158-2, 158-3, 158-4, 158-5, 158-N(collectively referred to as scanner instances 158). Dynamically scalable refers to the ability of the scanner cloud environment to automatically adjust the number of scanner instances based on the current demand for scanning services. This means that the system can increase or decrease the number of active scanner instances in response to the number of computing services that need to be scanned at any given time. Dynamic scalability allows the system to efficiently allocate resources, increase performance, and minimize computing power costs.

Deployment and execution of the data scanners are discussed in further detail below. Briefly, however, each scanner instance 158 can scan one (or more) computing service. For instance, as illustrated in FIG. 1, scanner instance 158-1 is configured to scan cloud service 110-1, scanner instance 158-4 is configured to scan on-premise service 152 and other scanner instances can scan SaaS applications 114 and/or data warehouses 116. Also, it is noted that one scanner instance can be configured to scan a plurality of different cloud services in some examples. These, of course, are for sake of example only.

Scanner results from scanner instances 158 are provided to system 150 to identify and analyze security posture data. For instance, system 150 can identify connected resources, entities, actors, etc. within the computing services and identify risks and violations against access to sensitive data. As shown in FIG. 1, system 150 can reside within cloud environment 102 or outside cloud environment 102, as represented by the dashed box in FIG. 1. Of course, system 150 can be distributed across multiple items inside and/or outside cloud environment 102.

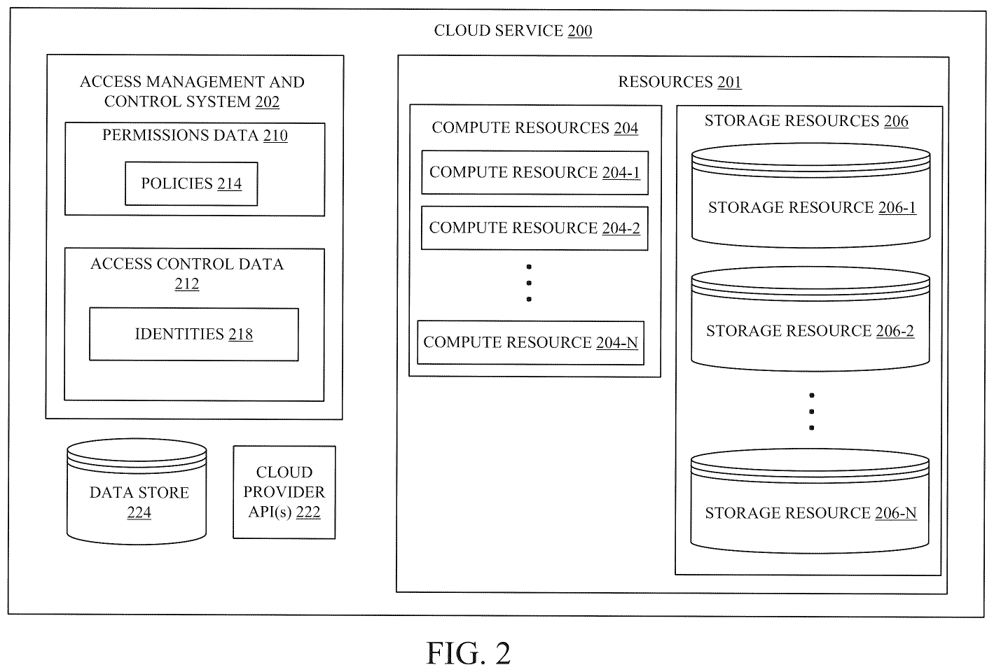

FIG. 2 is a block diagram illustrating one example of a cloud service 200, such as a target cloud service (e.g., cloud service 108-1) and/or a sidecar cloud service (e.g., cloud service 156). For the sake of the present discussion, but not by limitation, cloud service 200 will be discussed in the context of an account within AWS. Of course, other types of cloud services and providers are within the scope of the present disclosure.

Cloud service 200 includes a plurality of resources 201 and an access management and control system 202 configured to manage and control access to resources 201 by actors 104. Resources 201 include compute resources 204, storage resources 206, and can include other resources. Compute resources 204 include a plurality of individual compute resources 204-1, 204-2, 204-N, which can be the same and/or different types of compute resources. In the present example, compute resources 204 can include elastic compute resources, such as elastic compute cloud (AWS EC2) resources, AWS Lambda, etc.

An elastic compute cloud (EC2) is a cloud computing service designed to provide virtual machines called instances, where users can select an instance with a desired amount of computing resources, such as the number and type of CPUs, memory and local storage. An EC2 resource allows users to create and run compute instances on AWS, and can use familiar operating systems like Linux, Windows, etc. Users can select an instance type based on the memory and computing requirements needed for the application or software to be run on the instance.

AWS Lambda is an event-based service that delivers short-term compute capabilities and is designed to run code without the need to deploy, use or manage virtual machine instances. An example implementation is used by an organization to address specific triggers or events, such as database updates, storage changes or custom events generated from other applications. Such a compute resource can include a server-less, event-driven compute service that allows a user to run code for many different types of applications or backend services without provisioning or managing servers.

Storage resources 206 are accessible through compute resources 204, and can include a plurality of storage resources 206-1, 206-2, 206-N, which can be the same and/or different types of storage resources. A storage resource 206 can be defined based on object storage. For example, AWS Simple Storage Service (S3) provides highly-scalable cloud object storage with a simple web service interface. An S3 object can contain both data and metadata, and objects can reside in containers called buckets. Each bucket can be identified by a unique user-specified key or file name. A bucket can be a simple flat folder without a file system hierarchy. A bucket can be viewed as a container (e.g., folder) for objects (e.g., files) stored in the S3 storage resource.

Compute resources 204 can access or otherwise interact with storage resources 206 through network communication paths based on permissions data 210 and/or access control data 212. System 202 illustratively includes identity and access management (IAM) functionality that controls access to cloud service 200 using entities (e.g., IAM entities) provided by the cloud computing platform.

Permissions data 210 includes policies 214 and can include other permissions data 216. Access control data 212 includes identities 218 and can include other access control data as well. Examples of identities 218 include, but are not limited to, users, groups, roles, etc. In AWS, for example, an IAM user is an entity that is created in the AWS service and represents a person or service who uses the IAM user to interact with the cloud service. An IAM user provides the ability to sign into the AWS management console for interactive tasks and to make programmatic requests to AWS services using the API, and includes a name, password, and access keys to be used with the API. Permissions can be granted to the IAM user to make the IAM user a member of a user group with attached permission policies. An IAM user group is a collection of IAM users with specified permissions. Use of IAM groups can make management of permissions easier for those users. An IAM role in AWS is an IAM identity that has specific permissions, and has some similarities to an IAM user in that the IAM role is an AWS identity with permission policies that determine what the identity can and cannot do in AWS. However, instead of being uniquely associated with one person, a role is intended to be assumable by anyone who needs it. Roles can be used to delegate access to users, applications, and/or services that don't normally have access to the AWS resources. Roles can be used by IAM users in a same AWS account and/or in different AWS accounts than the role. Also, roles can be used by compute resources 204, such as EC2 resources. A service role is a role assumed by a service to perform actions in an account on behalf of a user. Service roles include permissions required for the service to access the resources needed by the service. Service roles can vary from service to service. A service role for an EC2 instance, for example, is a special type of service role that an application running on an EC2 instance can assume to perform actions.

Policies 214 can include identity-based policies that are attached to IAM identities can grant permissions to the identity. Policies 214 can also include resource-based policies that are attached to resources 201. Examples include S3 bucket policies and IAM role trust policies. An example trust policy includes a JSON policy document that defines the principles that are trusted to assume a role. In AWS, a policy is an object that, when associated with an identity or resource, defines permissions of the identity or resource. AWS evaluates these policies when an IAM principal user or a role) makes a request. Permissions in the policy determine whether the request is allowed or denied. Policies are often stored as JSON documents that are attached to the IAM identities (user, groups of users, role).

A permissions boundary is a managed policy for an IAM identity that defines the maximum permissions that the identity-based policies can grant to an entity, but does not grant the permissions. Further, access control lists (ACLs) control which principles in other accounts can access the resource to which the ACL is attached. ACLs can be similar to resource-based policies. In some implementations of the technology disclosed, the terms “roles” and “policies” are used interchangeably.

Cloud service 200 includes cloud provider application programming interface(s) (APIs) 222, a data store 224, and can include other items as well. As discussed in further detail below, a scanner is configured to access the cloud-based services and to scan the cloud service 200, for example to access the data stored in storage resources 206, permissions data 210, and access control data 212 to identify particular data patterns (such as, but not limited to, sensitive string patterns) and traverse or trace network communication paths between pairs of compute resources 204 and storage resources 206. The results of the scanner can be utilized to identify subject vulnerabilities, such as resources vulnerable to a breach attack, and to construct a cloud attack surface graph or other data structure that depicts propagation of a breach attack along the network communication paths.

Given a graph of connected resources, such as compute resources 204, storage resources 206, etc., entities (e.g., accounts, roles, policies), and actors (e.g., users, administrators), risks and violations against access to sensitive information is identified. A directional graph can be built to capture nodes that represent the resources and labels that are assigned for search and retrieval purposes. For example, a label can mark the node as a database or S3 resource, actors as users, administrators, developers, etc. Relationships between the nodes are created using information available from the cloud infrastructure configuration. For example, using the configuration information, system 150 can determine that a resource belongs to a given account and create a relationship between the policy attached to a resource and/or identify the roles that can be taken up by a user.

As noted above, in some examples, resources 201 can include AWS EC2 and/or Lambda resources. Also, resources 201 can include AWS Instance Stores and/or AWS Elastic Block Store (EBS) volumes. An EBS volume is a durable, block-level storage device that can attach to a compute instance and used as a physical hard drive.

Resources 201 can also include an Azure blob identified by a resource URL syntax that assigns each resource a corresponding base URL.

A cloud storage service or cloud service provider (CSP) can include an organization which hosts services such as networking, software, servers, and/or infrastructure, among others. A CSP can also provide security for the provided services. The services provided by the CSP can relieve a client organization of individual responsibility of setting and managing infrastructure. Examples of CSPs include Amazon Web Services™, Microsoft Azure™, Salesforce™, Google Cloud platform™, among others.

Cloud provider APIs 222 are configured to receive calls to access various components in cloud service 200. For example, cloud provider APIs 222 can access data stored in data store 224.

A CSP generally provides a number of different interfaces to cloud-computing services, such as a service-provider interface to organizational clients for computing services. A CSP, for example, provides interfaces that allow cloud-computing clients to launch virtual machines, application programs, and other computational entities. A CSP can also provide a user interface that allow clients to access, through the Internet, the services provided by the CSP. A client of the CSP can deploy web servers to access, modify, and send information.

A cloud account provided by a CSP includes roles that determine user privileges and what actions can be taken in the cloud account. An identity and access management (IAM) role is managed by the CSP and provides predefined roles that give granular access to specific CSP resources and prevents unwanted access to other CSP resources. For instance, an AWS IAM role includes an AWS identity with a set of permissions policies that each determine what the role can do within an AWS account. An IAM role can be assumed by anyone whose needs require the role.

For sake of illustration, but not by limitation, a service role can be assumed by an AWS service to perform actions on behalf of users. For instance, as a service that performs backup operations for a client, Amazon Data Lifecycle Manager requires that the client pass in a role to assume when performing policy operations on the client's behalf. That role must have an IAM policy with the permissions that enable Amazon Data Lifecycle Manager to perform actions associated with policy operations, such as creating snapshots and Amazon Machine Images (AMIs), copying snapshots and AMIs, deleting snapshots, and deregistering AMIs. Different permissions are required for each of the Amazon Data Lifecycle Manager policy types. The role must also have Amazon Data Lifecycle Manager listed as a trusted entity, which enables Amazon Data Lifecycle Manager to assume the role.

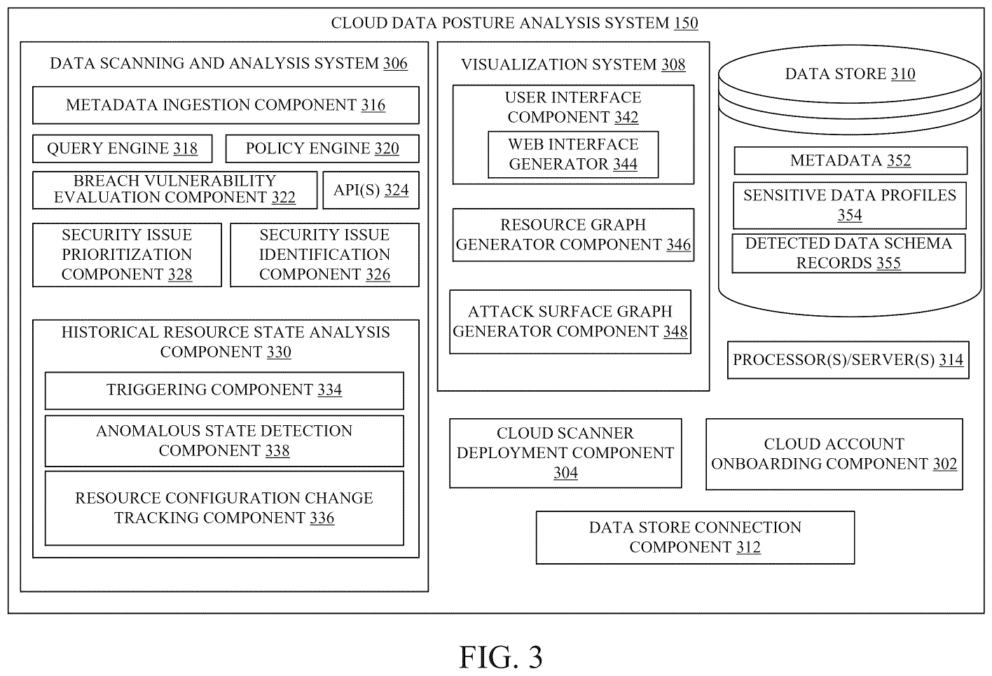

FIG. 3 is a block diagram illustrating one example of a cloud data posture analysis system 150. As noted above, system 150 can be deployed in cloud environment 102. In another example, system 150 can access cloud environment 102 through network 106 shown in FIG. 1.

System 150 includes a cloud account onboarding component 302, a cloud scanner deployment component 304, a data scanning and analysis system 306, a visualization system 308, and a data store 310. System 150 can also include a data store connection component 312, one or more processors or servers 314, and can include other items as well.

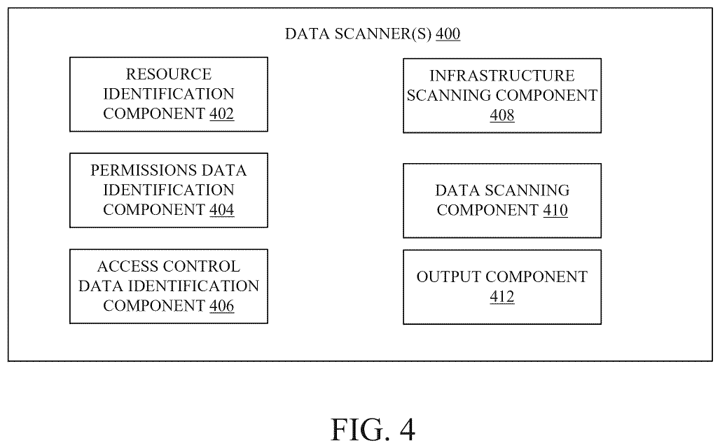

Cloud account onboarding component 302 is configured to onboard cloud services (or accounts) in one or more target cloud environments (e.g., cloud environments 108) for analysis by system 150. After onboarding, cloud scanner deployment component 304 is configured to deploy a data scanner (e.g., a data scanner 400 shown in FIG. 4) to scanner cloud environment 154 that is separate and distinct from target cloud environments 108 and on-premise services 152. For example, the data scanner can run in a sidecar cloud service to scan data stores in a plurality of different cloud services. Alternatively, or in addition, the data scanner can also scan SaaS application(s) 114, data warehouses 116, and on-premises services 152.

In one example, the data scanner includes on-demand agent-less scanners configured to perform agent-less scanning. One example of an agent-less scanner does not require agents to be installed on each specific device or machine. The scanners operate on resources 201 and access management and control system 202 directly within the cloud service, and generate metadata that is returned to system 150. Thus, in one example, the actual cloud service data is not required to leave the cloud service for analysis.

Data scanning and analysis system 306 includes a metadata ingestion component 316 configured to receive the metadata generated by data scanner 400. System 306 also includes a query engine 318, a policy engine 320, a breach vulnerability evaluation component 322, one or more application programming interfaces (APIs) 324, a security issue identification component 326, a security issue prioritization component 328, a historical resource state analysis component 330, and can include other items as well.

Query engine 318 is configured to execute queries against the received metadata and generated security issue data. Policy engine 320 can execute security policies against the cloud data and breach vulnerability evaluation component 322 is configured to evaluate potential breach vulnerabilities in the computing service. APIs 324 are exposed to users, such as administrators, to interact with system 150 to access the cloud security posture data.

The security issue identification component 326 is configured to identify cloud security issues and the security issue prioritization component 328 can prioritize the identified cloud security issues based on any of a number of criteria.

Historical resource state analysis component 330 is configured to analyze a history of states of resources 201. Historical resource state analysis component 330 includes a triggering component 334 configured to detect a trigger to perform historical resource state analysis. Triggering component 334 is configured to identify an event that triggers component 330 to analyze the state of resources 201. The event can be, for example, a user input to selectively trigger the analysis, or a detected event such as the occurrence of a time period, an update to a resource, etc. Accordingly, historical resource state can be tracked automatically and/or in response to user input.

Historical resource state analysis component 330 includes a resource configuration change tracking component 336 configured to track changes in the configuration of resources 201. Component 330 also includes an anomalous state detection component 338, and can include other items as well. Component 338 is configured to detect the occurrence of anomalous states in resources 201. A resource anomaly can be identified where a given resource has an unexpected state, such as a difference from other similar resources identified in the cloud service.

Visualization system 308 is configured to generate visualizations of the data posture from system 306. Illustratively, system 308 includes a user interface component 342 configured to generate a user interface for a user, such as an administrator. In the illustrated example, component 342 includes a web interface generator 344 configured to generate web interfaces that can be displayed in a web browser on a client device.

Visualization system 308 also includes a resource graph generator component 346, an attack surface graph generator component 348, and can include other items as well. Resource graph generator component 346 is configured to generate a graph or other representation of the relationships between resources 201. For example, component 346 can generate an infrastructure map that graphically depicts pairs of compute resources and storage resources as nodes and network communication paths as edges between the nodes.

Attack surface graph generator component 348 is configured to generate a surface graph or other representation of vulnerabilities of resources to a breach attack. In one example, the representation of vulnerabilities can include an attack surface map that graphically depicts propagation of a breach attack along network communication paths as edges between nodes that represent the corresponding resources.

Data store 310 stores metadata 352 obtained by metadata ingestion component 316, sensitive data profiles 354, detected data schema records 355, and can store other items as well. Sensitive data profiles 354 can identify target data patterns that are to be categorized as sensitive or conforming to a predefined pattern of interest. Sensitive data profiles 354 can be used as training data for data classification. For instance, pattern matching can be performed based on the target data profiles. Illustratively, pattern matching can be performed to identify instances of data patterns corresponding to social security numbers, credit card numbers, other personal data, medical information, to name a few. In one example, artificial intelligence (AI) is utilized to perform named entity recognition (e.g., natural language processing modules can identify sensitive data, in various languages, representing names, company names, and/or locations).

Detected data schema records 355 store detected instances of the target data profiles or entities that are returned based on content-based classification of the data. An example detected data schema record 355 can store any of a variety of different data items representing the detected instance corresponding to the data record, including, but not limited to, a data store identifier, a database identifier, a table name identifier, a column name identifier, a column type identifier, a target data entity identifier, and/or a confidence score, among other data. A data store identifier identifies a particular data store that contains the detected instance of the target data profiles.

Data store connection component 312 is configured to connect to, or access, the data stores of the resources being analyzed by system 150. This is discussed in further detail below. Briefly, however, data store connection component 312 can receive user access credentials, such as a username and password, for each data store of a plurality of data store to be accessed in the cloud environment and scanned by the deployed scanner(s).

FIG. 4 is a block diagram illustrating one example of a data scanner 400. Scanner 400 includes a resource identification component 402, a permissions data identification component 404, an access control data identification component 406, an infrastructure scanning component 408, a data scanning component 410, an output component 412, and can include other items as well.

Resource identification component 402 is configured to identify the resources 201 within a computing service, such as cloud services 110, 112, etc. and service 152 and to generate corresponding metadata that identifies these resources. Permissions data identification component 404 identifies the permissions data 210 and access control data identification component 406 identifies access control data 212. Infrastructure scanning component 408 scans the infrastructure of the computing service(s) to identify the relationships between resources 204 and 206 and data scanning component 410 scans the actual data stored in storage resources 206. Output component 412 is configured to output the generated metadata and content-based classification results to cloud data posture analysis system 150.

The metadata generated by scanner 300 can indicate a structure of schema objects in a data store. For example, where the schema objects comprise columns in a data store having a tabular format, the returned metadata can include column names from those columns.

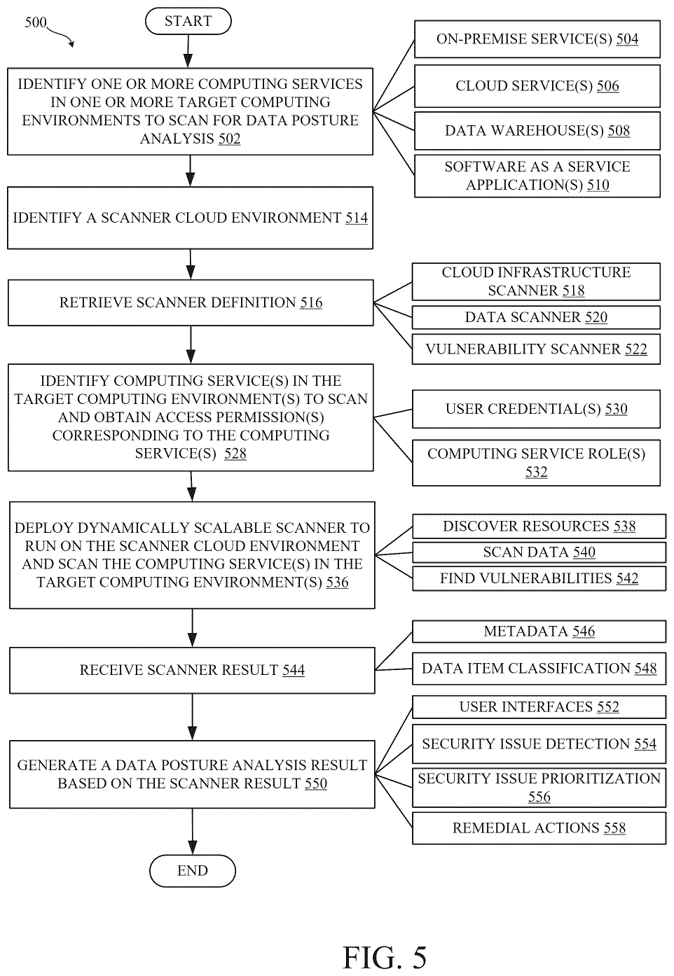

FIG. 5 is a flow diagram 500 illustrating one example of analyzing data posture in a computing environment. For sake of illustration, but not by limitation, FIG. 5 will be discussed in the context of architecture 100 shown in FIG. 1.

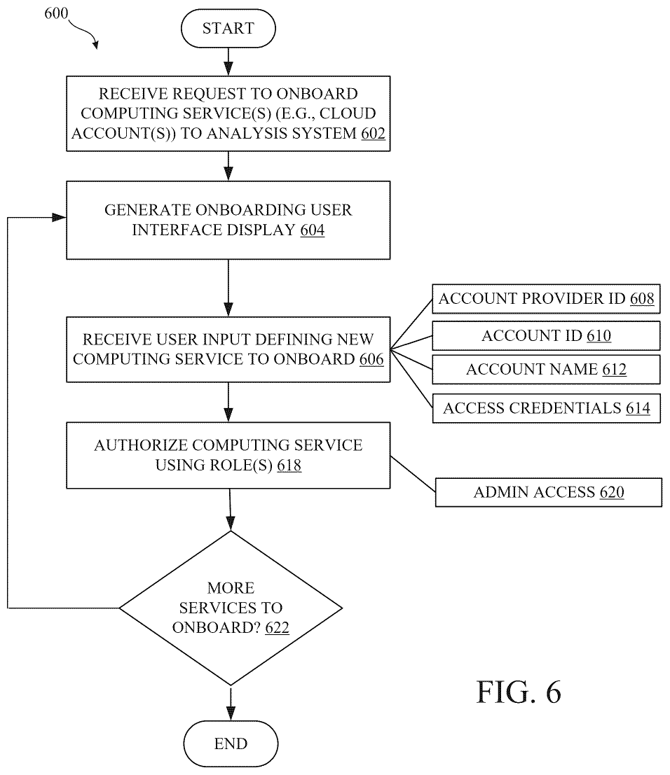

At block 502, one or more computing services in one or more target computing environments are identified to scan for data posture analysis. The one or more target computing environments can include on-premise services (block 504), cloud services (block 506), data warehouses (block 508), software as a service application(s) (block 510), and/or other types of services. In the context of FIG. 1, block 502 can identify cloud services 110 in cloud environment 108-1, cloud services 112 in target cloud environment 108-2, SaaS applications 114, data warehouses 116, and/or on-premise computing services 152. Some or all of the computing services can be associated with a particular organization or other end user. It is noted that the cloud services can include a multi-cloud in which cloud services for the organization are spread out across multiple different cloud providers. One example of identifying computing services is discussed below with respect to FIG. 6.

At block 514, the scanner cloud environment is identified. For instance, a sidecar account can be identified using a scanner cloud account definition control 806. Block 514 provides users the flexibility to select which public cloud provider to use as the sidecar account based on preferences, availability, or specific functionality requirements. Thus, an organization can leverage the strengths of different cloud platforms to optimize the scanning operations. Additionally, users can decide on the type of resources to deploy within the sidecar account, choosing between serverless computing options like AWS Lambda or Azure Functions, and virtual machines such as AWS EC2 or Google Compute Engine. This decision is influenced by factors such as the scalability needs, cost considerations, and the ease of management associated with each resource type. By customizing the deployment strategy, organizations can ensure that data posture analysis is conducted efficiently and effectively, while maintaining control over the operational aspects of the scanning process.

At block 516, a scanner definition is retrieved for the scanner to be deployed to the scanner cloud environment. For example, the scanner definition includes a deployment script for a containerized scanner in cloud service 156. The scanner can include a cloud infrastructure scanner (block 518), a data scanner (block 520), a vulnerability scanner (block 522), or other type of scanner.

In one example, a computing service role is attached to the scanner using the deployment script. Role-based assignment can facilitate secure and controlled access to computing resources required by the scanner during operation. The computing service role, which can correspond to a cloud identity and access management (IAM) role, service principal, or other authorization entity, can be configured to grant limited permissions. The deployment script, which can be written in a domain-specific language, a procedural script, or a cloud provider's native templating language, defines the computing service role with one or more associated access policies. These policies authorize the scanner to perform specific actions, such as retrieving objects from a storage service, querying instance metadata from a compute service, or accessing secrets from a secure vault.

Upon execution, the deployment script can programmatically generate or reference a pre-existing role, associate one or more permission policies with the role, and then instantiate the scanner module with a binding to the designated role. For example, when the scanner is deployed as part of a containerized task definition or a virtual machine instance, the deployment script includes configuration parameters that assign the specified role to the scanner at launch. In this manner, the scanner inherits the permissions defined by the attached role, thereby enabling controlled interaction with other system components and resources without the need to embed static credentials.

At block 528, one or more computing services in one or more target computing environments are identified to scan, and access permission(s) corresponding to the computing service(s) in the target computing environment(s) is/are obtained. In one example, the computing service(s) to scan can reside in a single on-premise or cloud environment. In another example, the computing service(s) can be distributed across a plurality of on-premise and/or cloud environments. For instance, in an example where there are one or more cloud services 110 in a first target cloud environment 108-1 and one or more cloud services 112 in a second target cloud environment 108-2, block 528 can obtain access permissions for each of the cloud services in each of the target computing environments.

For sake of illustration, but not by limitation, an organization can use a file system for on-premise data storage. In this case, cloud virtual machines can be configured to scan the on-premise data by establishing a secure communication channel between the file share and the scanner cloud environment, and mount the file share volume to the virtual machines to allow executing multiple data scanning jobs in parallel. The secure communication channel can implement encryption protocol and authentication methods, such as the use of digital certificates or secure tokens, to verify the identities of the communicating parties.

In another example, an organization uses Snowflake databases, and the scanner can be deployed on AWS as a Lambda function. This setup allows multiple serverless Lambda functions to be invoked simultaneously to scan and detect sensitive data within the Snowflake environment.

In another example, an organization utilizes AWS, GCP, Azure, and on-premise data stores. The organization can choose to deploy the scanner in a single location, such as a sidecar account, and initiate scans across all cloud environments from there. This centralized approach simplifies management and enhances scalability.

Access permissions can include, but are not limited to, user credentials at block 530, one or more computing service roles at block 532, or other types of access permissions.

At block 536, the scanner is deployed as a dynamically scalable scanner to run on the scanner cloud environment and scan the one or more computing services in the target computing environment. The scanner is dynamically scalable in that a number of scanner instances can be increased or decreased depending on the number of computing services to be scanned at a particular time. In this way, scanner cloud environment 154 automates the increase or decrease of resources needed in performing scans to the target cloud environment(s) 108 over time.

In one example, dynamic scaling of scanner instances involves the automatic adjustment of the number of active scanner instances in response to the current demand for scanning services across various target computing environments. This process can be managed by the cloud provider's infrastructure, which monitors the workload and resource utilization in real-time. When the system detects an increase in the number of computing services or data stores that require scanning, the system automatically provisions additional scanner instances to handle the increased load. This process can be achieved through the use of container orchestration platforms, such as Kubernetes, or serverless computing frameworks, such as AWS Lambda, which can rapidly deploy and manage multiple instances of the scanner application. Conversely, when the demand decreases, the system deallocates excess scanner instances to optimize resource usage and reduce costs. This elasticity ensures that the scanning operations are performed efficiently, maintaining high performance and minimizing latency, while also providing cost-effective resource management by scaling resources up or down based on actual needs.

The scanner can be deployed to discover resources at block 538, scan data at block 540, and/or find vulnerabilities at block 542.

In one example, a vulnerability can be identified based on finding a predefined risk signature in the computing service resources. The risk signatures can be queried upon, and define expected behavior within the computing service and locate anomalies based on this data.

At block 544, a scanner result is received from the scanner instances 158. The scanner result can include metadata (block 546) and/or data item classification (block 548). Other types of scanner results can also be received.

At block 550, a data posture analysis result is generated based on the scanner result received at block 544. Generating a data posture analysis result can include, but is not limited to, generating user interfaces at block 552 that render an indication of the data posture analysis result. Alternatively, or in addition, the result can include security issue detection at block 554, security issue prioritization at block 556, the performance of remedial actions at block 558, or other results. Examples of security issue detection and prioritization can include executing a query against the scanner results using vulnerability or risk signatures. The remedial actions at block 558 can include automated or user recommendations to configuration changes for cloud service settings/configurations.

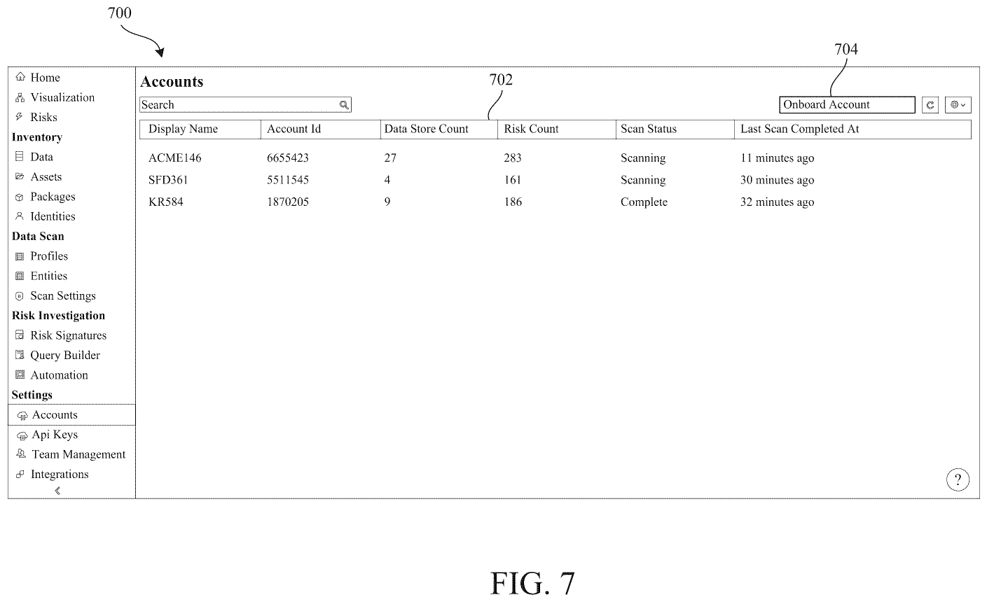

FIG. 6 is a flow diagram 600 illustrating one example of identifying computing services, such as at block 502. At block 602 a request to onboard computing services to analysis system 150 is received. An onboarding user interface display, such as a cloud formation template, is generated at block 604. One example of an onboarding user interface display is discussed below with respect to FIG. 7.

At block 606, user input is received defining a new computing service to onboard. The user input can include, but is not limited to, an account provider identifier 608, an account identifier 610, an account name, 612, access credentials 614, and other input. At block 618, the computing service can be authorized using roles, such as a role defining administrative access at block 620. At block 622, if more computing services are to be onboarded, operation returns to block 604.

FIG. 7 illustrates one example of an onboarding user interface display 700 provided to an administrator of an organization to onboard computing services of the organization to be scanned. Display 700 includes a display pane 702 in identifying accounts, such as cloud accounts, that have already been onboarded to system 150. Display 700 includes a control 704 that is actuatable to perform an onboarding process to onboard additional accounts to system 150. Display pane 702 displays information for each of the accounts, e.g., a name, an account ID, risk information, and/or a scanned status.

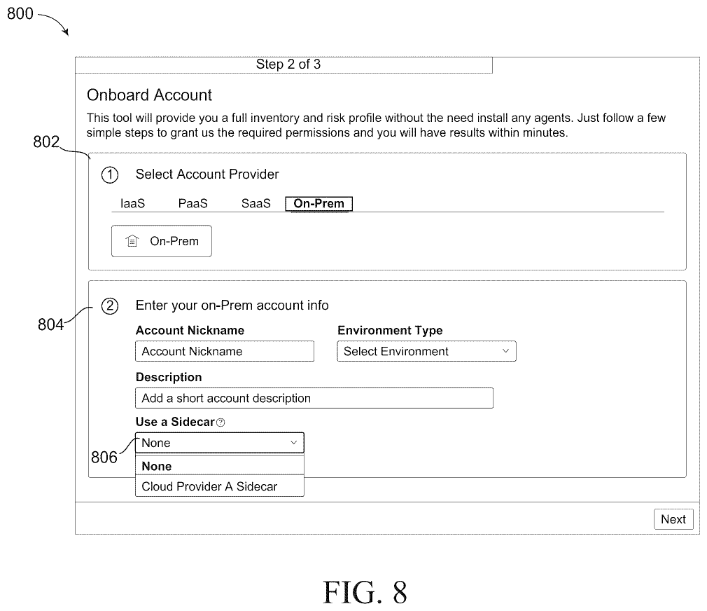

FIG. 8 illustrates one example of a user interface display 800 that can be displayed in response to actuation of control 704. Display 800 includes an account provider selection control 802 having selectable options corresponding to the type of account to be onboarded. For example, a user can select from infrastructure as a service (IaaS), platform as a service (PaaS), software as a service (SaaS) or an on-premise account. Based on the option selected in control 802, a control 804 includes fields for entering account information for the selected account provider. This can include providing an account nickname, an environment type, and a description. Additionally, for the account being onboarded, control 804 includes a scanner cloud account definition control 806 configured to receive an input to define whether a separate (e.g., a sidecar account) will be used to scan the target account being onboarded. Examples are discussed in further detail below.

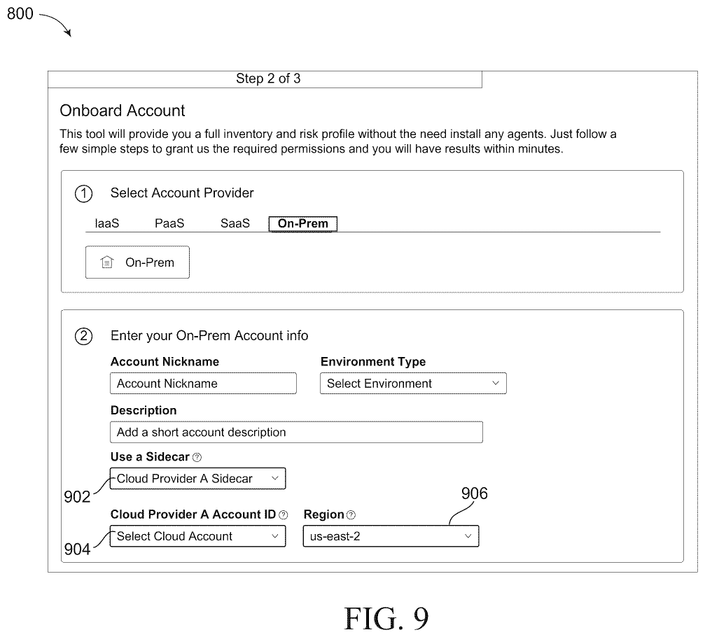

FIG. 9 illustrates display 800 after selection of a sidecar cloud account, as shown at reference numeral 902. Here, additional controls 904 and 906 are provided that allow the user to enter details of the sidecar cloud account being selected to use as the scanner environment.

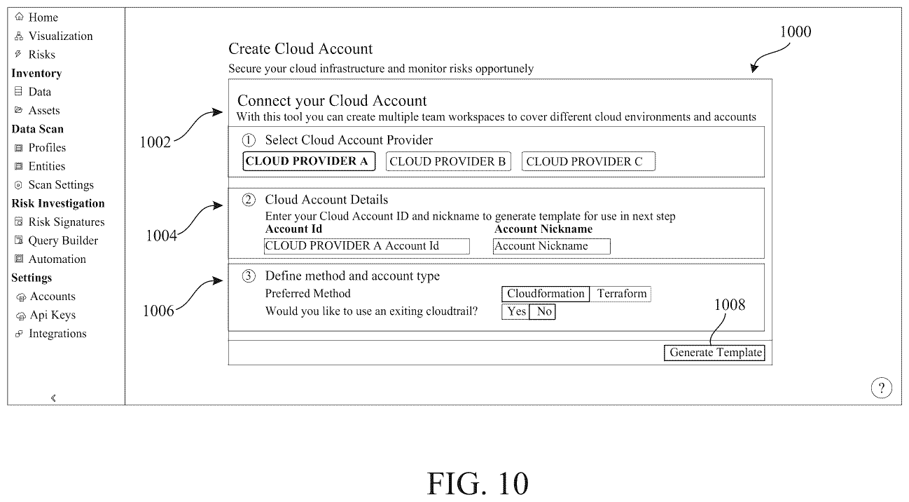

FIG. 10 illustrates one example of a user interface display 1000 that can be displayed in response to actuation of control 704. Display 1000 includes a user interface mechanism 1002 configured to receive input to select or otherwise define a particular cloud provider. In the illustrated example, mechanism 1002 includes a plurality of selectable controls representing different cloud providers.

Display 1000 includes a user input mechanism 1004 configured to receive input defining a cloud account identifier and an account nickname. User input mechanism 1006 is actuated to generate a cloud formation template, or other template, to be used in the onboarding process based on the selected cloud account provider.

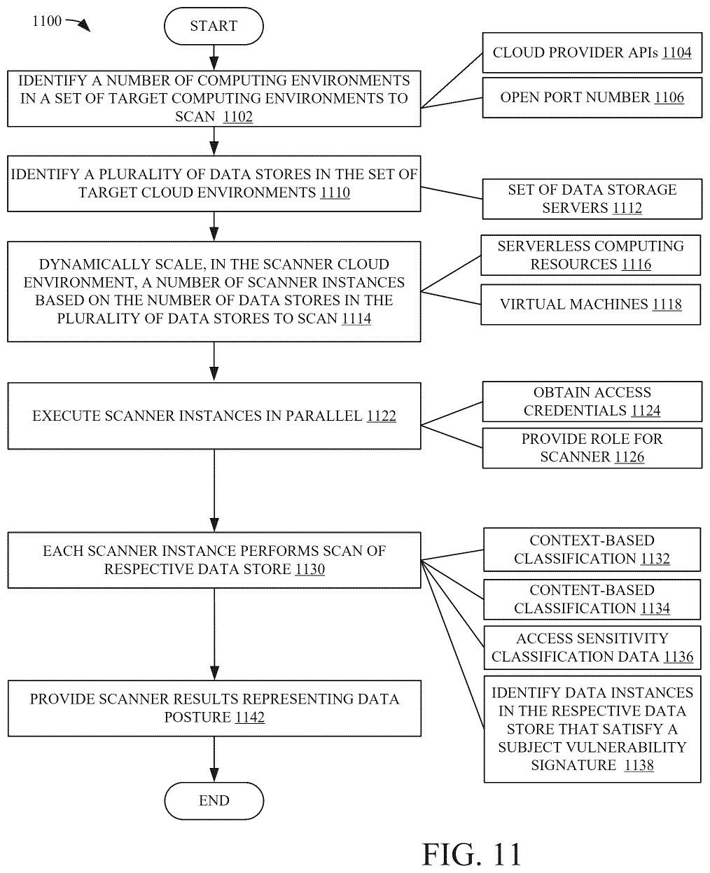

FIG. 11 is a flow diagram 1100 illustrating one example of executing scanner instances to scan data stores in the target cloud services. For sake of illustration, but not by limitation, FIG. 11 will be discussed in the context of data posture analysis system 150 illustrated in FIG. 1.

At block 1102, scanner cloud environment 154 identifies a number of computing environments, in a set of target computing environments, to be scanned. As noted above, the computing environments can include cloud environments as well as on-premise environments.

Accordingly, block 1102 can identify cloud provider application programming interfaces (APIs) at block 1104, open port numbers at block 1106, or other items.

In any case, block 1102 obtains information to identify which target cloud environments are to be scanned, as well as information to facilitate access to those target environments.

At block 1110, scanner cloud environment 154 identifies a plurality of data stores in the set of target cloud environments. In one example, the plurality of data stores includes a set of data storage servers 1112. Thus, each data store can include a server having one or more databases logically defined thereon.

At block 1114, the scanner cloud environment 154 dynamically scales, in the scanner cloud environment (e.g., in the sidecar cloud account), a number of scanner instances 158 based on the number of services to be scanned. For instance, a separate scanner instance can be created for each different data store to be scanned.

The scanner instances can execute on serverless computing resources (block 1116), virtual machines (block 1118), or in other ways.

At block 1122, the scanner instances are executed in parallel, for example by connecting each scanner instance to a particular data store in the plurality of data stores to be scanned. Each scanner instance obtains the appropriate access permissions for the service that the scanner instance is to scan. For example, this can include obtaining access credentials at block 1124, providing a role for the scanner at block 1126, or other permissions.

At block 1130, each scanner instance performs a scan of the respective data store (or other service being scanned). This can include a context-based scan, such as obtaining metadata representing a structure of the data store. Alternatively, or in addition, block 1130 can perform a content-based classification at block 1134, access sensitivity classification data at block 1136, and/or identify data instances in the respective data store that satisfy a subject vulnerability signature at block 1138.

An example subject vulnerability signature includes a predefined pattern and/or set of criteria used to identify potential security weaknesses within computing services or data stores. These signatures are defined based on known vulnerabilities, threat intelligence, or otherwise, and serve as benchmarks against which security posture of a system can be evaluated. To satisfy a subject vulnerability signature, the criterion defined in the signature, indicating a potential risk or exposure to security threats, are matched against characteristics or behaviors exhibited by a particular resource or data store. The process can involve scanning the resources to detect anomalies, such as misconfigurations, unauthorized access points, or outdated software versions, that align with the vulnerability signature. Once identified, these vulnerabilities can be prioritized for remediation to mitigate risks and enhance the overall security posture of the environment.

Of course, the scan can be performed in other ways as well. At block 1142, the scanner results representing data posture are provided to system 150.

It can thus be seen that the present disclosure describes technology for data posture analysis of computing service data that leverages cloud computing resources to dynamically deploy scanners. In some described examples, the technology can deploy containerized scanners through serverless computing resources and/or virtual machines in a manner that reduces resource management. Further, in described examples, scanners can be deployed to environments that otherwise do not support scanning functionality. An organization that uses a number of different types of computing services, such as cloud services, on-premise services, data warehouses, etc. can deploy a scanner to one specific location, such as a sidecar cloud account, and trigger scans for all of the accounts in a flexible and highly scalable manner. All of this improves data posture analysis and the ability to implement data security and facilitate discovery of security vulnerabilities to understand the data posture, detect and remediate vulnerabilities, such as to prevent breaches of sensitive and/or private data.

One or more implementations of the technology disclosed or elements thereof can be implemented in the form of a computer product, including a non-transitory computer readable storage medium with computer usable program code for performing the method steps indicated. Furthermore, one or more implementations and clauses of the technology disclosed or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

Examples discussed herein include processor(s) and/or server(s). For sake of illustration, but not by limitation, the processors and/or servers include computer processors with associated memory and timing circuitry, and are functional parts of the corresponding systems or devices, and facilitate the functionality of the other components or items in those systems.

As used herein, if a description includes “one or more of” or “at least one of” followed by a list of example features with a conjunction “or” between the penultimate example feature and the last example feature, then this is to be read such that (1) one exemplary embodiment includes at least one of or one or more of each feature of the listed features, (2) another exemplary embodiment includes at least one of or one or more of only one feature of the listed features, and (3) another exemplary embodiment includes some combination of the listed features that is less than all of the features and more than one of the features.

As used herein, if a description includes “one or more of” or “at least one of” followed by a list of example features with a conjunction “and” between the penultimate example feature and the last example feature, then this is to be read such that the exemplary embodiment includes at least one of or one or more of each feature of all the listed features.

As used herein, if a description includes “one or more of” or “at least one of” followed by a list of example features with a conjunction “and/or” between the penultimate example feature and the least example feature, then this is to be read such that, in one example, the description includes “one or more of” or “at least one of” followed by a list of example features with a conjunction “or” between the penultimate example feature and the last example feature, and, in another example, the description includes “one or more of” or “at least one of”′ followed by a list of example features with a conjunction “and” between the penultimate example feature and the last example feature.

Also, user interface displays have been discussed. Examples of user interface displays can take a wide variety of forms with different user actuatable input mechanisms. For instance, a user input mechanism can include icons, links, menus, text boxes, check boxes, etc., and can be actuated in a wide variety of different ways. Examples of input devices for actuating the input mechanisms include, but are not limited to, hardware devices (e.g., point and click devices, hardware buttons, switches, a joystick or keyboard, thumb switches or thumb pads) and virtual devices (e.g., virtual keyboards or other virtual actuators). For instance, a user actuatable input mechanism can be actuated using a touch gesture on a touch sensitive screen. In another example, a user actuatable input mechanism can be actuated using a speech command.

The present figures show a number of blocks with corresponding functionality described herein. It is noted that fewer blocks can be used, such that functionality is performed by fewer components. Also, more blocks can be used with the functionality distributed among more components. Further, the data stores discussed herein can be broken into multiple data stores. All of the data stores can be local to the systems accessing the data stores, all of the data stores can be remote, or some data stores can be local while others can be remote.

The above discussion has described a variety of different systems, components, logic, and interactions. One or more of these systems, components, logic and/or interactions can be implemented by hardware, such as processors, memory, or other processing components. Some particular examples include, but are not limited to, artificial intelligence components, such as neural networks, that perform the functions associated with those systems, components, logic, and/or interactions. In addition, the systems, components, logic and/or interactions can be implemented by software that is loaded into a memory and is executed by a processor, server, or other computing component, as described below. The systems, components, logic and/or interactions can also be implemented by different combinations of hardware, software, firmware, etc., some examples of which are described below. These are some examples of different structures that can be used to implement any or all of the systems, components, logic, and/or interactions described above.

The elements of the described figures, or portions of the elements, can be disposed on a wide variety of different devices. Some of those devices include servers, desktop computers, laptop computers, tablet computers, or other mobile devices, such as palm top computers, cell phones, smart phones, multimedia players, personal digital assistants, etc.

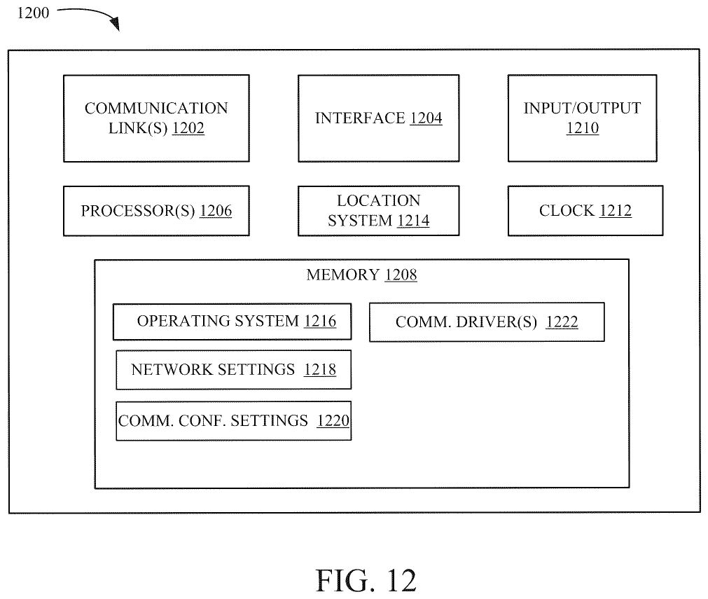

FIG. 12 is a simplified block diagram of one example of a client device 1200, such as a handheld or mobile device, in which the present system (or parts of the present system) can be deployed.

One or more communication links 1202 allows device 1200 to communicate with other computing devices, and can provide a channel for receiving information automatically, such as by scanning. An example includes communication protocols, such as wireless services used to provide cellular access to a network, as well as protocols that provide local wireless connections to networks.

Applications or other data can be received on an external (e.g., removable) storage device or memory that is connected to an interface 1204. Interface 1204 and communication links 1202 communicate with one or more processors 1206 (which can include processors or servers described with respect to the figures) along a communication bus (not shown in FIG. 12), that can also be connected to memory 1208 and input/output (I/O) components 1210, as well as clock 1212 and a location system 1214.

Components 1210 facilitate input and output operations for device 1200, and can include input components such as microphones, touch screens, buttons, touch sensors, optical sensors, proximity sensors, orientation sensors, accelerometers. Components 1210 can include output components such as a display device, a speaker, and or a printer port.

Clock 1212 includes, in one example, a real time clock component that outputs a time and date, and can provide timing functions for processor(s) 1206. Location system 1214 outputs a current geographic location of device 1200 and can include a global positioning system (GPS) receiver, a LORAN system, a dead reckoning system, a cellular triangulation system, or other positioning system. Memory 1208 stores an operating system 1216, network applications and corresponding configuration settings 1218, communication configuration settings 1220, communication drivers 1222, and can include other items. Examples of memory 1208 include types of tangible volatile and non-volatile computer-readable memory devices. Memory 1208 can also include computer storage media that stores computer readable instructions that, when executed by processor(s) 1206, cause the processor to perform computer-implemented steps or functions according to the instructions. Processor(s) 1206 can be activated by other components to facilitate functionality of those components as well.

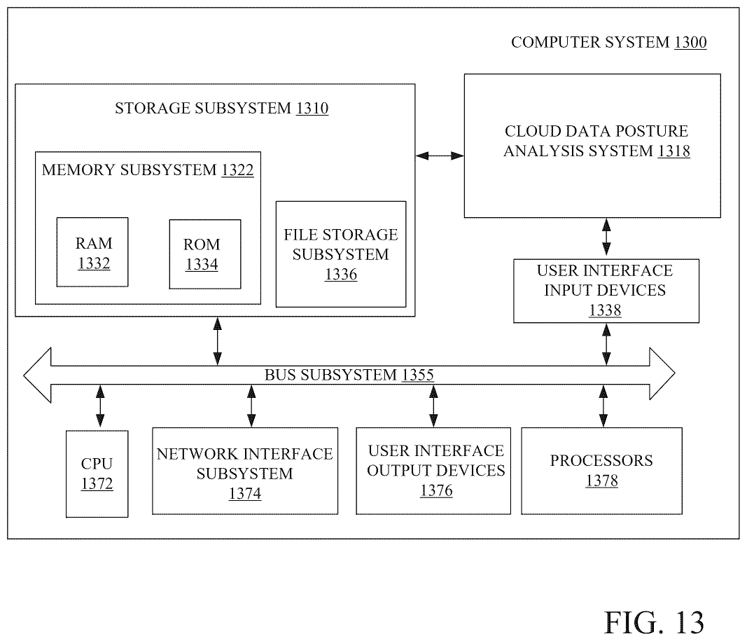

FIG. 13 shows an example computer system 1300 that can be used to implement the technology disclosed. Computer system 1300 includes at least one central processing unit (CPU) 1372 that communicates with a number of peripheral devices via bus subsystem 1355. These peripheral devices can include a storage subsystem 1310 including, for example, memory devices and a file storage subsystem 1336, user interface input devices 1338, user interface output devices 1376, and a network interface subsystem 1374. The input and output devices allow user interaction with computer system 1300. Network interface subsystem 1374 provides an interface to outside networks, including an interface to corresponding interface devices in other computer systems.

In one implementation, cloud data posture analysis system 1318 is communicably linked to the storage subsystem 1310 and the user interface input devices 1338. System 1318 can include some or all components of system 150, discussed above.

User interface input devices 1338 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1300.

User interface output devices 1376 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1300 to the user or to another machine or computer system.

Storage subsystem 1310 stores programming and data constructs that provide the functionality of some or all of the modules and methods described herein. These software modules are generally executed by processors 1378.

Processors 1378 can be graphics processing units (GPUs), field-programmable gate arrays (FPGAs), application-specific integrated circuits (ASICs), and/or coarse-grained reconfigurable architectures (CGRAs). Processors 1378 can be hosted by a deep learning cloud platform such as Google Cloud Platform™, Xilinx™, and Cirrascale™.

Memory subsystem 1322 used in the storage subsystem 1310 can include a number of memories including a main random access memory (RAM) 1332 for storage of instructions and data during program execution and a read only memory (ROM) 1334 in which fixed instructions are stored. A file storage subsystem 1336 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1336 in the storage subsystem 1310, or in other machines accessible by the processor.

Bus subsystem 1355 provides a mechanism for letting the various components and subsystems of computer system 1300 communicate with each other as intended. Although bus subsystem 1355 is shown schematically as a single bus, alternative implementations of the bus subsystem can use multiple busses.

Computer system 1300 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1300 depicted in FIG. 13 is intended only as a specific example for purposes of illustrating the preferred implementations of the present invention. Many other configurations of computer system 1300 are possible having more or less components than the computer system depicted in FIG. 13.

It should also be noted that the different examples described herein can be combined in different ways. That is, parts of one or more examples can be combined with parts of one or more other examples. All of this is contemplated herein.

The technology disclosed can be practiced as a system, method, or article of manufacture. One or more features of an implementation can be combined with the base implementation. Implementations that are not mutually exclusive are taught to be combinable.

One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
identifying one or more computing services in a target computing environment to scan for data posture analysis;
obtaining an access permission corresponding to the one or more computing services in the target computing environment;
deploying, to a scanner cloud environment that is distinct from the target computing environment, a scanner in accordance with a scanner definition and based on the access permission corresponding to the one or more computing services;
obtaining a scanner result from the scanner deployed to the scanner cloud environment, the scanner result representing a scan of storage resources in the one or more computing services in the target computing environment using the access permission; and
generating a data posture analysis result based on the scanner result.

2. The computer-implemented method of claim 1, wherein the target computing environment comprises a target cloud environment, and the one or more computing services comprise one or more cloud data stores.

3. The computer-implemented method of claim 2, wherein the target cloud environment comprises public cloud resources.

4. The computer-implemented method of claim 1, wherein the access permission comprises a computing service role, and the computer-implemented method further comprises attaching the computing service role to the scanner using a deployment script of the scanner.

5. The computer-implemented method of claim 1, wherein the access permission comprises a user credential.

6. The computer-implemented method of claim 5, wherein the user credential includes a username and a password corresponding to the one or more computing services.

7. The computer-implemented method of claim 1, wherein the scanner is deployed to a sidecar account.

8. The computer-implemented method of claim 7, wherein the sidecar account comprises a sidecar account in a public cloud.

9. The computer-implemented method of claim 8, wherein the target computing environment comprises a first cloud account associated with a user and the sidecar account comprises a second cloud account associated with the user, and the computer-implemented method further comprises retrieving the scanner definition based on the first cloud account.

10. The computer-implemented method of claim 1, wherein the one or more computing services comprises a plurality of computing services, and the scanner cloud environment is configured to generate a plurality of scanner instances configured to scan the plurality of computing services in parallel.

11. The computer-implemented method of claim 10, wherein the scanner cloud environment is configured to dynamically scale a number of scanner instances, in the plurality of scanner instances, based on a number of computing services in the plurality of computing services to be scanned.

12. The computer-implemented method of claim 10, wherein the scanner is deployed on one or more of:
a serverless computing resource in the scanner cloud environment; or
a virtual machine in the scanner cloud environment.

13. The computer-implemented method of claim 10, wherein the plurality of computing services comprises a first computing service and a second computing service, wherein each computing service, of the first computing service and the second computing service, comprises a different one of:
a cloud service;
a cloud data warehouse;
a software as a service application; or
an on-premise computing service.

14. The computer-implemented method of claim 1, wherein the scanner is configured to access sensitivity classification data for objects in the storage resources, and the data posture analysis result is based on the sensitivity classification data.

15. The computer-implemented method of claim 14, wherein the scanner is configured to identify a set of the storage resources that satisfies a subject vulnerability signature and to return metadata representing the set of storage resources.

16. A computing system comprising:
at least one processor;
memory storing instructions executable by the at least one processor, wherein the instructions, when executed, cause the computing system to:
identify a plurality of computing services in one or more target computing environments to scan for data posture analysis;
obtain access permissions corresponding to the plurality of computing services;
deploy, to a scanner cloud environment that is distinct from the one or more target computing environments, a scanner in accordance with a scanner definition,
wherein the scanner cloud environment is configured to dynamically scale a number of scanner instances, in a plurality of scanner instances that execute in parallel to scan the plurality of computing services using the access permissions, based on a number of computing services in the plurality of computing services to be scanned;
obtain a scanner result from the scanner cloud environment, the scanner result representing a scan of storage resources in the plurality of computing services; and
generate a data posture analysis result based on the scanner result.

17. The computing system of claim 16, wherein the scanner is deployed on one or more of:
a serverless computing resource in the scanner cloud environment; or
a virtual machine in the scanner cloud environment.

18. The computing system of claim 16, wherein the plurality of computing services comprises a first computing service and a second computing service, wherein each computing service, of the first computing service and the second computing service, comprises a different one of:
a cloud service;
a cloud data warehouse;
a software as a service application; or
an on-premise computing service.

19. A computing system comprising:
at least one processor;
memory storing instructions executable by the at least one processor, wherein the instructions, when executed, cause the computing system to:
identify a plurality of cloud accounts in one or more target cloud environments to scan for data posture analysis;
obtain access permissions corresponding to the plurality of cloud accounts;
deploy, to a sidecar cloud account in scanner cloud environment that is distinct from the one or more target cloud environments, a scanner in accordance with a scanner definition,
wherein the scanner cloud environment is configured to execute, in parallel, a plurality of scanner instances to scan the plurality of cloud accounts using the access permissions;
obtain a scanner result from the scanner cloud environment, the scanner result representing a scan of storage resources in the plurality of cloud accounts; and
generate a data posture analysis result based on the scanner result.

20. The computing system of claim 19, wherein the scanner is deployed on one or more of:
a serverless computing resource in the scanner cloud environment; or
a virtual machine in the scanner cloud environment.
